(19) United States
(12) Patent Application Publication
(10) Pub. No.: US 2016/0010585 A1
(43) Pub. Date: Jan. 14, 2016

(54) A CYLINDER SLEEVE TO BE INSERTED INTO AN ENGINE BLOCK AND AN ENGINE BLOCK

(71) Applicants: MAHLE METAL LEVE S/A, Jundiaí - SP (BR); MAHLE INTERNATIONAL GMBH, Stuttgart (DE)

(72) Inventor: Rodrigo Favaron, São Paulo (BR)

(73) Assignees: Mahle Metal Leve S/A, Jundiaí (BR); Mahle International GmbH, Stuttgart (DE)

(21) Appl. No.: 14/773,210

(22) PCT Filed: Apr. 25, 2013
(86) PCT No.: PCT/BR2013/000131

§ 371 Date: Sep. 4, 2015

(30) Foreign Application Priority Data
Mar. 5, 2013 (BR) BR102013005236-0

(51) Int. Cl. F02F 1/00

(52) U.S. Cl. CPC F02F 1/004

(57) ABSTRACT

A cylinder sleeve for an aluminum engine block of an internal combustion engine may include a cylinder body for insert casting into the engine block. The cylinder body may be composed of a cast iron material and include a circumferential outer surface configured to face the engine block. A coating may be disposed via electrodeposition on the outer surface of the cylinder body. The coating may be composed of a nickel/phosphorous alloy and include a phosphorous content ranging from 1 percent to 70 percent.

### CROSS-REFERENCE TO RELATED APPLICATIONS

This application claims priority to Brazilian Patent Application No. 102013005326-0, filed Mar. 5, 2013, and International Patent Application No. PCT/BR2013/000131, filed Apr. 25, 2013, both of which are hereby incorporated by reference in their entirety.

### TECHNICAL FIELD

The present invention relates to a component of an internal combustion engine, more specifically at least one cylinder sleeve inserted by casting into an engine block, the circumferential outer surface being provided with a coating capable of promoting excellent adhesion and heat exchange between the sleeve and the engine block, regardless of the casting technology employed.

### BACKGROUND

Due to the new market demands, internal components of engines undergo greater requirements and, in this regard, they need to exhibit solutions capable of guaranteeing a better performance, as well as to contribute to greater reliability and output of the engine.

A number of manufacturers of automotive components seek different technical solutions for cylinder sleeves of internal combustion engines, among others, it should be noted that cylinders of internal combustion engines may be formed by cylinder sleeves that are inserted into the engine block by casting of the engine block around the circumferential outer portion of the sleeves.

Today, the tendency is to use engine blocks made of aluminum, the weight reduction of which contributes to fuel saving, which results in less environmental impact by the vehicle. As will be seen later, there are two processes for casting engine blocks that can be used to inlay cylinder sleeves, namely: high-pressure die cast (HPDC) and low-pressure die cast (LPDC), also known as gravity casting. The great difference between the two is that the former makes use of pressure for injecting the aluminum into the mold and, as a result, the metal is at a lower temperature than in low-pressure die cast.

Regardless of the technical solution employed, cylinder sleeves of internal combustion engines are engine components that undergo significant wear due to the type of work which they perform. Among the stresses to which they are subjected, one points out the axial strain of the sleeve inside the cylinder bore and the capacity of pouring combustion heat to the engine block.

The pouring of heat and the sleeve-wall thickness are important factors to minimize thermal and mechanical distortions in operation. Engines with greater distortions tend to exhibit a higher level of wear of their components, as well as higher levels of consumption of oil, fuel and emissions of CO₂. Thus, the increase in the heat exchange has various beneficial effects, since this prevents excessive wear of components and improves the conditions of consumption of fuel, oil and emissions of polluting gases. Additionally, it should be noted that a better heat exchange also enables one to reduce engine-block dimensions.

As a rule, cylinder sleeves are composed of a ferrous material, especially cast iron, the more modern engine blocks being cast with aluminum or an aluminum alloy, usually containing silicon. In this way, the technological field of the present invention comprises cylinder sleeves made of cast iron, engine blocks of any aluminum alloy, as well as high and low pressure die cast.

With a view to solve the problems inherent in the technology of internal combustion engine provided with inserted cylinder sleeves, German document DE19729071 presents a cylinder sleeve the outer surface of which exhibits wrinkles in the axial direction for locking the latter on the engine block. Additionally, this document presents the use of a thermal spray process to form a coating on the outer surface of the cylinder sleeve. Such a coating comprises an aluminum-silicon (Al—Si) alloy with silicon contents lower than 15%.

According to the German document, the external surface of the cylinder sleeve may receive said AlSi layer directly or, alternatively, there may be an intermediate binding layer deposited onto it. Moreover, one may also deposit a thin zinc layer after the AlSi layer, with a view to provide protection against oxidation. Thus, this document comprises at least one AlSi layer deposited on the outer face of the cylinder sleeve by thermal spray, both before and after the AlSi layer.

However, it should be noted that the solution presented by the German document does not manage to solve the typical problems that result from the casting of the engine block onto the cylinder sleeves. First, even though there is a concern about trying to find a certain chemical parity of the coating with the alloy of the engine by using an aluminum layer of up to 15% of silicon, due to the parity of the alloy the coating exhibits the same melting point, point of transformation of solid phase into liquid phase of the material of the block alloy, such an embodiment has the disadvantage that, at the moment when the liquid metal is cast in the mold of the engine block and involves the cylinder sleeves, it begins to heat the sleeve coating material, promoting the transformation of phase of the coating. Such transformation causes the coating material to be totally consumed by the cast material of the engine block, thus exposing the ferrous material of the cylinder sleeve and generating the defects, contact failure (empty spaces—see reference number 15 in FIG. 6), in the region of the engine block adjacent the cylinder sleeves.

These casting defects, hereinafter empty spaces, have, as a great drawback, the fact of impairing the correct heat exchange from the combustion that takes place inside the cylinder to the engine block, increasing thermal distortions and leading to early wear of the engine, or even to stoppage thereof for lack of lubrication. Moreover, the sleeve has large thickness ranging from 1.2 mm to 8.0 mm, the applied coating having a thickness ranging from 0.25 mm to 2.5 mm (see FIG. 7), which shows a coating with large thickness 5).

The American patent U.S. Pat. No. 7,757,652 also discloses a solution to the association between a cylinder sleeve made of cast iron and an engine block made of aluminum. This document makes use of cold spray application of a metallic aluminum or aluminum-alloy, copper or copper-alloy layer that is deposited onto the outer surface of the cylinder sleeve.

The great focus of the technology presented by this American document refers to the formation of a specific rugosity on the deposited layer for better adhesion to the engine block. Even though that document comments that the deposited layer is highly heat conductive, this solution, just as in the above-cited German document, makes use of a coating in layers having different melting points, which will also give rise to empty spaces in the molten metal and, as a result, a less efficient heat exchange. Thus, although the technology of patent U.S. Pat. No. 7,757,652 is successful in providing adhesion between the cylinder sleeve and the engine block, it does not manage to guarantee a good heat exchange also due to defects that appear in the interface between the molten material and the sleeve or close to it.

The Japanese prior-art document JP2008008209 discloses a hybrid cylinder sleeve that receives an AlSi layer by thermal spraying. Just as the German technique presented before, the production of the engine block containing one of these sleeves (coated with AlSi alone), takes place by high pressure die cast (HPDC). Thus, this (liquid) metal is launched at a melting temperature close to the ‘liquidus’ line of the phase diagram of AlSi, since the time for solidification of the liquid metal should be quite reduced. Otherwise, if one employs a higher temperature, typical of the low pressure die cast (LPDC), the layer added by thermal spraying would be liquefied altogether, and the benefits of applying an AlSi layer would be lost, and the typical defects that impair the heat exchange required for proper operation of the engine would appear, such as empty spaces between the engine block and the cylinder sleeve (see FIG. 6). These defects are aggravated when the block is cast by gravity, that is, by low pressure die cast (LPDC).

Thus, the technology disclosed by this Japanese document only enables casting of the block by high pressure die cast, and does not enable one to make use of the gravity cast. In the cases where the casting is made by low pressure cast the above-indicated technologies do not manage to promote a good thermal-expansion gradient, nor do they guarantee an excellent anchorage that could enable greater heat exchange. It should also be noted that the commented technologies do not enable flexibility in the temperature of the molten metal for the formation of the block, as compared with the coating of the present invention, which exhibits a varying melting point as a function of the casting technology and of the temperature of the liquid material added to the foundry mold.

Whatever the solution used in the prior art, one will be only partially successful, without achieving good results concomitantly for both engine blocks obtained by high pressure die cast and for engine blocks obtained by low pressure die cast.

In addition to the above-indicated difficulties, one observes that an AlSi coating, obtained by thermal spraying, usually has thickness higher than 200/300 microns (see FIG. 7). When the metal of the engine block is molten, and the higher its injection/casting temperature the more or less rapidly it will consume the coating of the cylinder sleeve. Even if it is possible to vary the coating thickness in an attempt to prevent its total consumption due to its fusion, which gives rise to the above-mentioned defects, this solution does not prove to be practical for two reasons. On the one hand, the increase in thickness makes the coating applied to the cylinder sleeve expensive; on the other hand it increases the interbore (The measure between the center of a sleeve and the center of the adjacent sleeve is the measure used for qualifying the dimension of the engine block. The smaller the interbore; the smaller the engine block, for the same cylinder diameter). Moreover, none of the coatings applied by the prior art has, as an objective, the possibility of altering its chemical composition, so that the melting point can be altered, which would contribute directly to the solution of a part of the above-mentioned problems.

Alternatively, a coating may also be made of a pure metal (such as nickel applied by electrodeposition). Unlike the AlSi coating, thermal spraying, the pure nickel (Ni) material may be the solution to the casting methods by low pressure or gravity (see FIG. 8), with an adequate diffusion of nickel with aluminum. The Japanese document JPS5930465 discloses a pure nickel (Ni) or copper (Cu) coating as a binding element between the cast iron of the cylinder sleeve and the aluminum of the engine block. With regard to this document, due to the high melting point of pure nickel (about 1400° C.), the diffusion may not take place adequately when it is applied by high pressure die cast (see empty spaces in FIG. 9).

Thus, it is necessary to find a solution that will enable one to insert cast-iron sleeves into engine blocks of aluminum alloys by means of any casting technology (HPDC or LPDC), enabling better adhesion between the sleeve and the engine block, as well as a better heat exchange and a reduction of the interbore, thereby guaranteeing long durability internal combustion engines.

### SUMMARY

Therefore, it is an objective of the present invention to provide a cylinder sleeve having a coating capable of inhibiting the formation of empty spaces in the bond with the engine block, guaranteeing excellent adhesion and, as a result, good heat exchange between the combustion chamber and the engine block.

It is also an objective of the invention to provide a cylinder sleeve made of cast iron, provided with a coating made of nickel/phosphorus (NiP) alloy, which can be applied by any casting method, with either high or low pressure, thus enabling one to vary the melting point of the coating allow as a function of the method used.

It is a further objective of the invention to provide a cylinder sleeve, the coating of which has thickness ranging from 10 to 20 microns, comprising from 1% to 70% phosphorus and that enables a reduction of interbores of the inserted cylinder sleeves.

The objectives of the present invention are achieved by forming a cylinder sleeve for insertion into an engine block of an internal combustion engine, the cylinder sleeve comprising a cylindrical body made of cast iron, provided with a circumferential outer surface involved by a coating deposited on the outer surface, the coating comprising a nickel/phosphorus (NiP) alloy applied by electrodeposition and comprising from 1% to 79% phosphorus.

The objectives of the present invention are further achieved by providing an engine block for internal combustion having at least one cylinder sleeve as defined above.

### BRIEF DESCRIPTION OF THE DRAWINGS

The present invention will now be described in greater detail with reference to examples of embodiment represented in the drawings. The figures show:

FIG. 1 shows a perspective view of a cylinder sleeve;

FIG. 2 shows an engine block provided with the cylinder sleeves;

FIG. 3 is a photograph of the metallographic structure of a cross section of a cylinder sleeve of the present invention, showing the thickness of the coating;

FIG. 4 is a photograph of the metallographic structure of a cross section of a cylinder sleeve of the present invention after it has been inserted into an aluminum engine block;

FIG. 5a is a graph showing the increase in bond strength of the coatings of the present invention with respect to the prior-art coating;

FIG. 5b is a graph showing the increase in thermal conductivity of the present invention with respect to the prior-art coating;

FIG. 6 is a photograph of the metallographic structure of a cross section of a cylinder sleeve of the prior art, showing the thickness of an AlSi coating on a cast-iron sleeve after it has been inserted into an aluminum block by gravity casting (LPDC);

FIG. 7 is a photograph of the metallographic structure of a cross section of a cylinder sleeve of the prior art, showing the thickness of an AlSi coating on a cast-iron sleeve after it has been inserted into an aluminum block by high pressure die cast (HPDC);

FIG. 8 is a photograph of the metallographic structure of a cross section of a cylinder sleeve, showing the thickness and diffusion of a pure nickel coating on a cast-iron sleeve after it has been inserted into an aluminum block by gravity casting (LPDC);

FIG. 9 is a photograph of the metallographic structure of a cross section of a cylinder sleeve, which shows the thickness and diffusion of a pure nickel casting on a cast-iron sleeve after it has been inserted into an aluminum block by high pressure die cast (HPDC);

FIG. 10 is a top view of an engine block with the cylinder sleeves inserted;

FIG. 11 is a top view of a detail of the engine block, showing the distance between the inserted cylinder sleeves.

### DETAILED DESCRIPTION

The field of the present invention relates to internal combustion engines, particularly to the interaction between the cylinder sleeves 10 and the respective engine block 8. By casting/injection of liquid metal around the cylinder sleeves 10, previously arranged in the respective mold, one achieves an engine block with the sleeves 10 inserted into it. Typically, the metal of the engine block is a light metal, such as aluminum or an aluminum alloy.

The cylinder sleeve 10, as stated, needs to ensure its adhesion to the engine block 8, as well as guarantee that, after cooling of the liquid metal cast in the mold, no empty regions 15, without metal (casting defects), will appear. As explained in the prior art, guaranteeing this combination is something complex.

In order to understand the present invention correctly, it is necessary to clarify a few concepts and paradigms. As defined above, there are two types of casting for inserting cylinder sleeves into engine blocks made of aluminum alloys. High pressure die cast, hereinafter called HPDC and low pressure die cast, hereinafter called LPDC. The HPDC is the most widely used one and compensates for the lower temperature of the aluminum with the pressurized injection thereof. In these cases, the coatings 5 tend to be less consumed, since aluminum cools rapidly. In the LPDC the coatings, for the same thickness, tend to undergo greater wear, giving rise to the so-called empty spaces 15 (see FIG. 6). Thus, it should be noted that the technology employed for casting the block, according to the present-day concepts, interacts directly with the coating 5 thickness and, as a result, with the amount of heat exchange.

Additionally, one has to achieve good adhesion between the sleeve 10 and the engine block 8, which results directly from the chemical parity between the coating 5 and the aluminum alloy of the engine block 8.

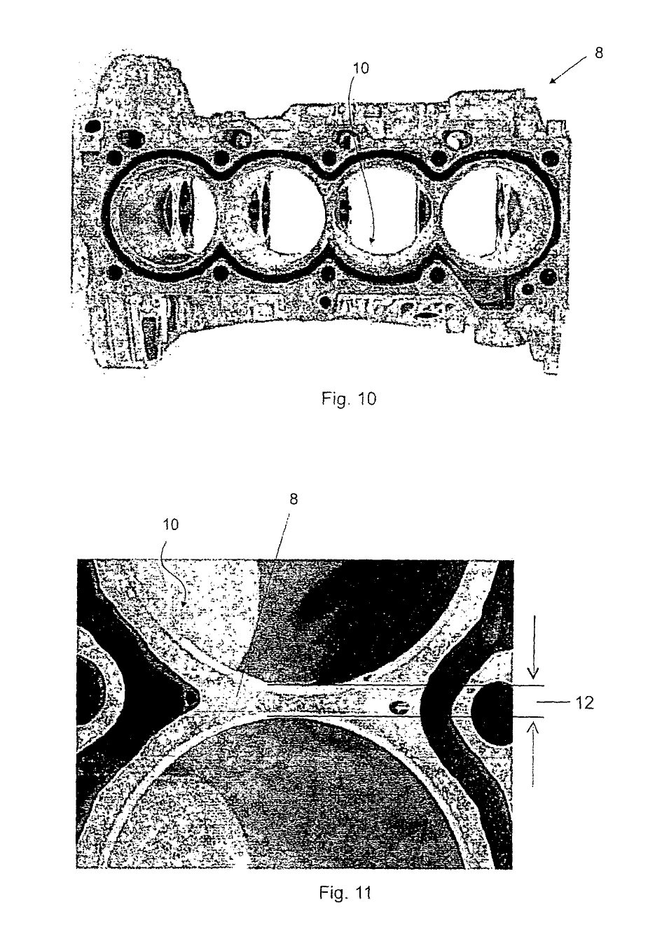

Finally, one should consider the size of the engine block 8. As it is known, the main engine fitting companies put pressure on engine developers so that they will reduce the engine size, which means that they will reduce the interbore (see FIGS. 9 and 10). In this regard, any reduction of the coating 5 thickness will result in a reduction of the interbore. Talking into consideration the fact that with the LPDC the prior-art coating need to be thicker in order not to generate empty spaces 15, the existence of a coating 5 that manages to reduce the interbore, while being less thick and still enabling the insertion of the sleeve by one of the two casting technologies (HPDC and LPDC) proves to be a double advantageous solution. As will be seen, the present invention not only manages to combine these two technologies, but also achieves adhesion strength superior to the prior-art solutions.

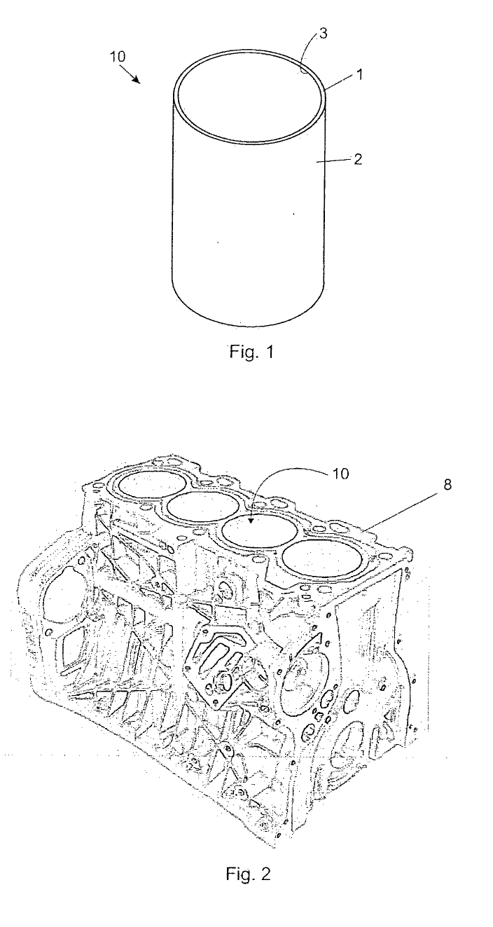

As shown in FIG. 1, a cylinder sleeve 10 is provided with a cast tube of cylindrical body 1, usually constituted by a ferrous alloy, such as cast iron or gray cast iron. This cylindrical body 1 provides two surfaces, in particular, namely: the inner surface 3, where the axial movement of a piston will take place, and the circumferential outer surface 2. It is this external region that will be involved by the liquid metal of the engine block 8, but only after the outer surface 2 has been subjected to the coating 5, thus configuring the present invention.

The coating 5 of the present invention is applied directly onto the outer surface 2 without special preparation (there are only the washing, degreasing and acidic activation steps, which are typical of galvonoplasty processes), being constituted by a nickel/phosphorus (NiP) alloy, applied by an electrodeposition process. It should be noted that the use of the process of applying the coating 5 by electrodeposition is one of the main reasons that guarantee the results of the present invention. In the prior art one usually employs thermal spraying processes, such as cold spray, known also as metallization, which result in coating thicknesses larger than 200 microns. On the other hand, it is possible to provide coatings with thicknesses that range from 5 to 20 microns, that is, a value that is 10% lower than that achieved by the prior art. This characteristic alone already guarantees a reduction of the interbore in a very significant way.

With regard to the chemical composition of the coating 5, the nickel/phosphorus alloy may contain from 1% to 70% phosphorus for creating the bond layer with the engine block 8 (see FIG. 4). With regard to the alloy employed, two observations should be made.

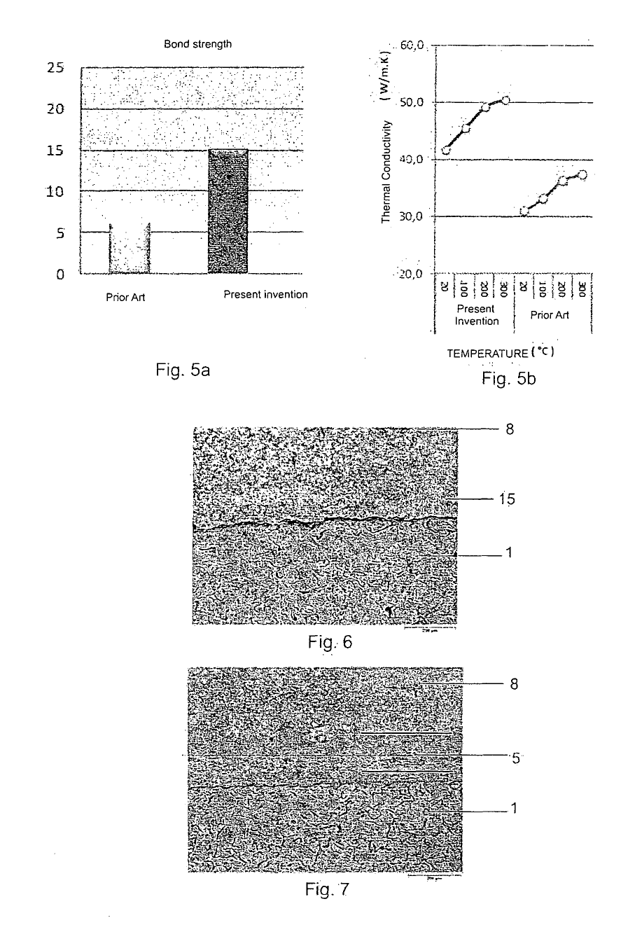

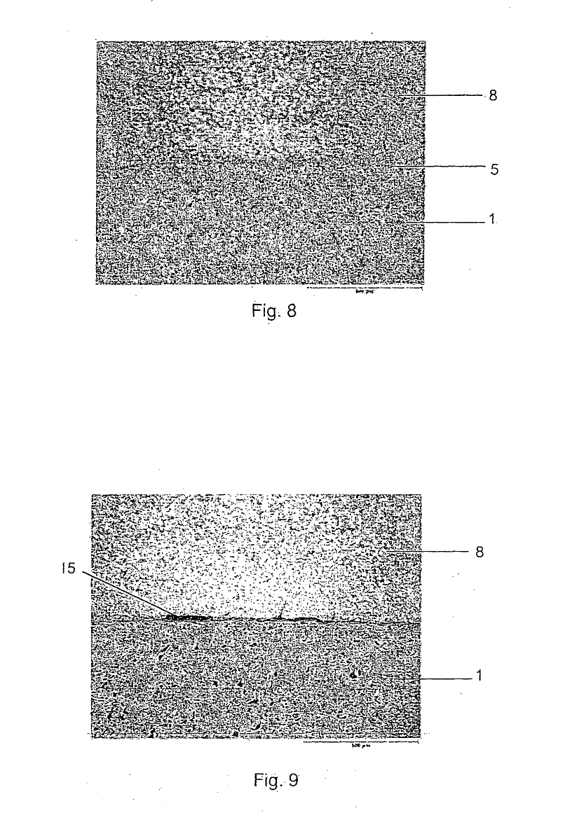

On the one hand, it is known that nickel has excellent chemical parity with aluminum, forming intermediate phases containing the two materials, which is easily observed by means of an Al-Ni balance diagram. A proof of this are the excellent results achieved in measuring the adhesion strength of the sleeve 10 to the engine block 8. FIG. 5 shows clearly that the present invention (NiP coating 5 with the sleeve inserted by HPDC) achieves adhesion strength superior to 6 Mpa, being preferably of 15 Mpa, a value that is quite higher than about 5 Mpa achieved by AlSi coatings applied by thermal spraying. Greater bond strength improves the heat exchange (greater heat transfer).

Studies were carried out for the purpose of comparing the thermal conductivity of the present invention with the prior art (see FIG. 12). The values showed clearly that, at a determined temperature (similar to the operation temperature of the cylinder sleeves, namely 200° C.), the present invention (NiP coating 5 with the sleeve inserted for HPDC) exhibited thermal conductivity of 49 (W/mK), a value that is 36% higher than the thermal conductivity of the prior art (AlSi coating applied by spray), which represented thermal conductivity of 36 (W/mK). FIG. 12 shows that the present invention has clear advantage in thermal conductivity over the prior art, which, in turn, promotes better distortion control of the bore of the cylinder sleeve 10 and also better clearance between the piston and the sleeve 10. In this way, reduction is achieved in the consumption of lubricant oil and in the consumption of fuel (considering the tangential lower loads of the ring to reduce friction) and, as a result, less emissions of CO₂.

On the other hand, by handling the phosphorus contents one can alter the melting point of the NiP alloy of the coating 5. The more reduced the phosphorus contents the higher the melting point of the alloy. Such a handling may be easily assisted by means of a Ni—P balance diagram. In this way, it is possible, for the same coating 5 thickness, to vary the melting point of the alloy, so that the sleeve 10 can be inserted by either HPDC or LPDC, without consuming the coating 5.

It should be further pointed out that the present invention manages to provide insertions of sleeves 10 without empty spaces, as shown in FIG. 4.

The advantage of a NiP coating over all those existing in the prior art (such as the pure Ni coating) is related to the possibility of adjusting the melting point of the NiP alloy). In order to clarify better how such variation in the amount of phosphorus interferes with the melting point and the casting process chosen, on should observe the examples given hereinafter.

For HPDC, since the temperature of the aluminum of the engine block 8 is lower and the injection time is reduced, the ideal NiP alloy should have a melting point as low as possible, so as to facilitate the formation of the intermetallic AlNi phase. In these cases, preferably but not compulsorily, the NiP alloy should have an amount of phosphorus ranging from 30% to 70%, which causes a reduction in the melting point to about 860° C. In this way, an adequate diffusion between the NiP coating and the aluminum alloy is guaranteed (see FIG. 4).

For LPDC and gravity casting processes, since the aluminum of the engine block is at higher temperatures and the coating 5 remains exposed to the hot aluminum longer, one prevents that the coating 5 from being totally diffused into the aluminum, raising the melting point of the NiP alloy. In this way, the amount of phosphorus varies substantially from 1% to 12%, reducing the melding point of the NiP alloy from 1455° C. to 891° C.

This mechanism for handling the amount of phosphorus guarantees results that are much superior to those in which the coating 5 is applied with pure nickel. A large amount of phosphorus enables one to reduce the melting point to about 700° C. and a reduced amount of phosphorus (from 1% to 3%) enables one to reduce the melting point to about 900° C., thus enabling the engine block 8 to be cast by HPDC or LPDC, respectively. It should be noted that the metallurgical diffusion in the bond of the coating 5 of the sleeves 10 with the engine block 8 is important to guarantee good mechanical properties, shearing stresses and bond strength, as well as to guarantee good transfer of heat between the cylinder sleeve 10 and the engine block 8, these advantages being guaranteed by the present invention (see FIG. 5b).

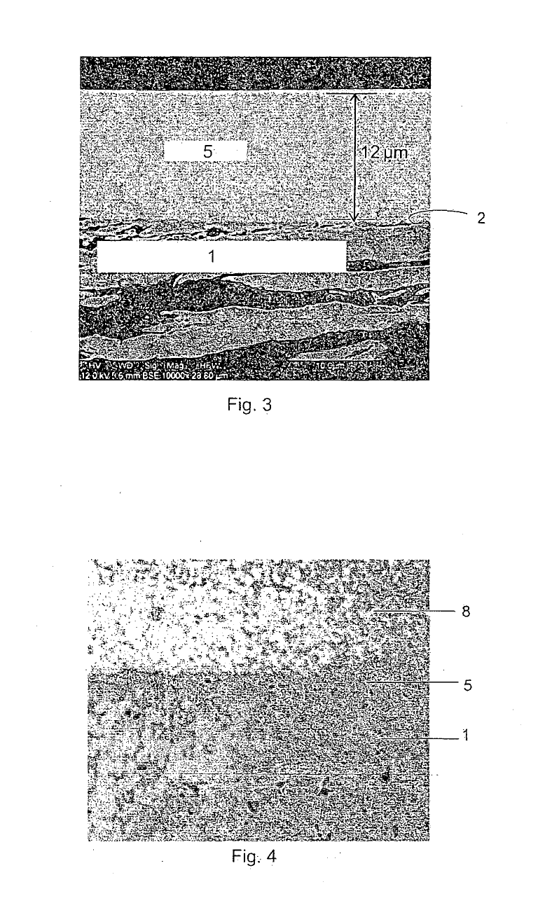

The concept of the present invention is thus an alternative to modern engines, the engine block 8 of which makes use of an aluminum alloy. Since the thickness of the coating 5 is quite thin, for example, 10 or 12 microns (see FIG. 3), good adhesion of the sleeve 10 together with the low tolerances in the outer diameter of the sleeve 10, enable one to configure compact engine block 8, that is, with a reduced distance of the interbore.

In comparison with the thermal spray process employed by the prior art, which needs coatings with thicknesses of about 200 microns, due to the specific characteristics of the process, the present invention employs, for instance, a 10-micron coating, this different resulting in a reduction of the opening between the cylinders (interbore) (see FIG. 10).

For instance, considering that, for the AlSi thermal spray technology the wall thickness is of 0.8 mm, the result of the total interbore spacing is of 3.0 mm. On the other hand, the result of the interbore spacing is of 2.62 mm, that is, there is a reduction of 12.5% in the interbore spacing due to the thinner thickness of the coating 5. This reduction means a considerable reduction in weight of the engine block 8, which is the great objective of the main manufacturers due to the above-indicated advantages.

Preferred examples of embodiments having been described, it should be understood that the scope of the present invention embraces other possible variations, being limited only by the contents of the accompanying claims, which include the possible equivalents.

1. A cylinder sleeve for an aluminum engine block of an internal combustion engine, comprising:
a cylinder body for insert casting into the engine block and composed of a cast iron material, the cylinder body including a circumferential outer surface configured to face the engine block, and a coating disposed via electrodeposition on the outer surface of the cylinder body, wherein the coating is composed of a nickel/phosphorus alloy and includes a phosphorus content ranging from 1% to 70%.

2. The cylinder sleeve according to claim 1, wherein the coating defines a coating depth extending transverse to the outer surface, and wherein the phosphorus content is different in a direction along the coating depth.

3. The cylinder sleeve according to claim 1, wherein the coating has a thickness ranging from 5 microns to 30 microns.

4. The cylinder sleeve according to claim 1, wherein the coating has a thermal conductibility of at least 35 W/mK.

5. The cylinder sleeve according to claim 1, wherein the coating includes a bond strength to the cylinder body and the engine block that is higher than 6 Mpa.

6. The cylinder sleeve according to claim 1, wherein the cylinder body is inserted into the engine block via at least one of high pressure die casting, low pressure die casting and gravity casting.

7. The cylinder sleeve according to claim 1, wherein the coating further includes a rugosity on at least one surface sufficient to define a bond strength to the cylinder body and the engine block of at least 6 Mpa.

8. An engine block of an internal combustion engine, comprising: at least one cylinder sleeve coupled to the engine block via insert casting, the at least one cylinder sleeve including:
a hollow cylinder body composed of a cast iron material and defining a circumferential outer surface facing towards the engine block; and
a coating disposed on the outer surface via electrodeposition, wherein the coating is composed of a nickel/phosphorous alloy and includes a phosphorous content ranging from 1% to 70%.

9. The engine block according to claim 8, wherein the coating defines a coating depth extending transverse to the outer surface, and wherein the phosphorous content is different in a direction along the coating depth.

10. The engine block according to claim 8, wherein the coating has a thickness ranging from 5 microns to 30 microns.

11. The engine block according to claim 8, wherein the coating has a thermal conductibility of at least 35 W/mK.

12. The engine block according to claim 8, wherein the coating includes a bond strength to the at least one cylinder sleeve and the engine block of at least 6 Mpa.

13. The engine block according to claim 12, wherein the bond strength of approximately 15 Mpa.

14. The engine block according to claim 12, wherein the coating has a thermal conductibility of at least 35 W/mK.

15. The engine block according to claim 14, wherein the coating has a thickness ranging from 5 microns to 30 microns.

16. The engine block according to claim 8, wherein the at least one cylinder sleeve is cast into the engine block via high pressure die casting.

17. The engine block according to claim 8, wherein the at least one cylinder sleeve is cast into the engine block via low pressure die casting.

18. The engine block according to claim 8, wherein the at least one cylinder sleeve is cast into the engine block via gravity casting.

19. A cylinder sleeve of an internal combustion engine, comprising:
a cylinder body coupled to an aluminum engine block via insert casting, the cylinder body composed of a cast iron material and having a circumferential outer surface facing the engine block; and
a coating disposed on the outer surface via electrodeposition, wherein the coating is composed of a nickel/phosphorous alloy, includes a phosphorous content ranging from 1% to 70%, and has a thermal conductibility of at least 35 W/mK;
wherein the coating further includes a bond strength to the cylinder body and the engine block that is higher than 6 Mpa.

20. the cylinder sleeve according to claim 19, wherein the cylinder body is insert cast into the engine block via at least one of high pressure die casting and low pressure die casting.
